(19) United States
(12) Patent Application Publication
(10) Pub. No.: US 2025/0354802 A1
(43) Pub. Date: Nov. 20, 2025

(54) SHAPE MEASUREMENT DEVICE AND SHAPE MEASUREMENT METHOD

(71) Applicant: HITACHI HIGH-TECH CORPORATION, Tokyo (JP)

(72) Inventors: Masahiro WATANABE, Tokyo (JP); Tatsuo HARIYAMA, Tokyo (JP); Kenji MARUNO, Tokyo (JP); Hirohito AKIYAMA, Tokyo (JP); Hidehiko KANDO, Tokyo (JP)

(21) Appl. No.: 18/871,514

(22) PCT Filed: May 29, 2023
(86) PCT No.: PCT/JP2023/019832

§ 371 Date: Dec. 4, 2024

(30) Foreign Application Priority Data
Jul. 20, 2022 (JP) 2022-115246

(51) Int. Cl. G01B 11/24; B25J 19/02

(52) U.S. Cl. CPC G01B 11/24; B25J 19/021

(57) ABSTRACT

When a multi-joint robot is adopted in a shape measurement device, the shape of an object is measured with high accuracy without adding an additional drive shaft to the multi-joint robot. The shape measurement device includes a multi-joint robot having a plurality of drive shafts and a non-contact distance measuring sensor attached to the multi-joint robot, in which the multi-joint robot drives only a predetermined single shaft among the plurality of drive shafts to scan an object with measurement light emitted from the non-contact distance measuring sensor.

### TECHNICAL FIELD

The present invention relates to a shape measurement device and a shape measurement method. The present invention claims priority to Japanese Patent Application No. 2022-115246 filed on Jul. 20, 2022, and the contents of that application are incorporated by reference into this application in designated countries where incorporation by reference of literature is permitted.

### BACKGROUND Art

As technology for measuring the shape of an object, for example, PTL 1 discloses technology in which a rotating rotor is attached to the tip of a Z axis of an XYZ stage of a three-dimensional coordinate measurement system, a probe is attached to a position that is offset from a rotor shaft by a radius R, and the rotor is rotated to rotate the probe and measure the shape of the object.

### CITATION LIST

### Patent Literature

PTL 1: JP2008-241714A

### SUMMARY OF INVENTION

### Technical Problem

In the technology disclosed in PTL 1, when a measurement surface of an object is horizontal, it is sufficient to adopt a simple probe with a fixed emission direction of measurement light. However, when the surface of the object faces in various directions, it is necessary to use a multi-joint probe that can change the emission direction of measurement light. Multi-joint probes are expensive because of their complex structures. In addition, multi-joint probes are heavy due to their complex structures, and thus the accuracy of movement thereof is low.

Instead of using a multi-joint probe, it is also conceivable to use a method of attaching a simple probe with a fixed emission direction of measurement light to the tip of an arm of a multi-joint robot and driving the probe. However, in this case, when the accuracy of movement of the multi-joint robot is not sufficient, the accuracy of measurement of the surface of an object will be limited.

The invention has been made in consideration of the above points, and an object thereof is to measure the shape of an object with high accuracy when a multi-joint robot is adopted in a shape measurement device, without adding an additional drive shaft to the multi-joint robot.

### Solution to Problem

The present application includes a plurality of means for solving at least some of the above problems, and examples thereof are as follows.

To solve the above problems, a shape measurement device according to one aspect of the invention includes a multi-joint robot having a plurality of drive shafts, and a non-contact distance measuring sensor attached to the multi- joint robot, in which the multi-joint robot drives only a predetermined single shaft among the plurality of drive shafts to scan an object with measurement light emitted from the non-contact distance measuring sensor.

### Advantageous Effects of Invention

According to the invention, when a multi-joint robot is adopted in a shape measurement device, it is possible to measure the shape of an object with high accuracy without adding an additional drive shaft to the multi-joint robot.

Problems, configurations, and effects other than those described above will become apparent from the description of the following embodiments.

### BRIEF DESCRIPTION OF DRAWINGS

FIG. 1 is a schematic diagram showing an example of a shape measurement device according to a first embodiment of the invention.

FIG. 2 is a schematic diagram showing a configuration example of a measurement probe.

FIG. 3 is a schematic diagram showing a modification example of the measurement probe.

FIG. 4 is a schematic diagram showing another modification example of the measurement probe.

FIG. 5 is a diagram showing a first example of scanning of the measurement probe and a method of processing a measured profile.

FIG. 6 is a diagram showing a second example of scanning of a measurement probe and a method of processing a measured profile.

FIG. 7 is a diagram showing a modification example of a probe tip part.

FIG. 8 is a diagram showing an example of scanning of a measurement probe and a method of processing a measured profile, corresponding to a modification example of a probe tip part.

FIG. 9 is a schematic diagram showing an example of a shape measurement device according to a second embodiment of the invention.

FIG. 10 is a diagram showing a configuration example of a shape measurement system including a shape measurement device.

### DESCRIPTION OF EMBODIMENTS

Hereinafter, a plurality of embodiments of the invention will be described with reference to the drawings. In all drawings for describing each embodiment, the same members are generally given the same reference numerals, and repeated descriptions will be omitted. Further, in the following embodiments, the components (including element steps, and the like) are not necessarily essential, unless otherwise specified or considered to be obviously essential in principle. Furthermore, when “consists of A”, “constituted by A”, “has A”, and “includes A” are mentioned, other elements are not excluded, except when specifically specified to include only that element. Similarly, in the following embodiments, when referring to the shapes, positional relationships, and the like of components and the like, it includes those that are substantially close or similar to that shape and the like, except when specifically specified or considered to be obviously not essential in principle.

### Configuration Example of Shape Measurement Device 100₁ According to First Embodiment of Invention

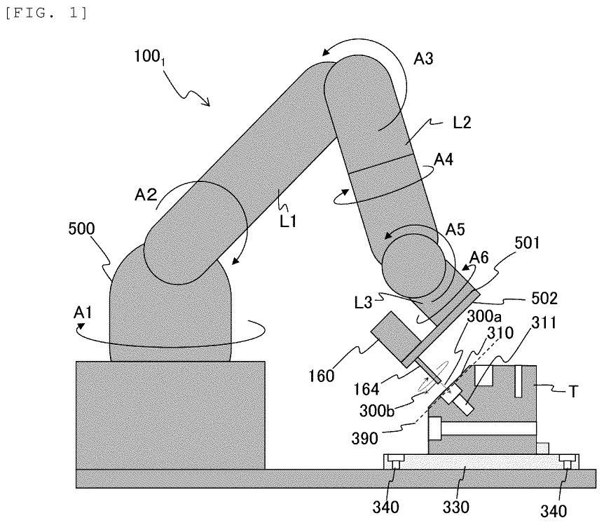

FIG. 1 shows a configuration example of a shape measurement device 100₁ according to a first embodiment of the invention. The shape measurement device 100₁ includes a multi-joint robot 500, a measurement probe 160, and a sample stage 330.

The multi-joint robot 500 is, for example, a 6-axis vertical multi-joint robot having six drive shafts A1 to A6.

The measurement probe 160 corresponds to a non-contact distance measuring sensor of the invention. The measurement probe 160 is fixed to a flange 502 provided at an end 501 of an arm L3 of the multi-joint robot 500. The measurement probe 160 is moved by the multi-joint robot 500 to approach an object T from various positions, various orientations, and various directions, and emits measurement light from its tip to measure the shape of the object T.

A relative positional relationship between the sample stage 330 on which the object T is placed and the multi-joint robot 500 is fixed. If possible, it is desirable to mount the object T by pressing it against a predetermined position on the sample stage 330 so that the position of the object T on the sample stage 330 can be mounted with good reproducibility. In this case, the position of the object T can be accurately measured by measuring two or more alignment marks 340 formed on the sample stage 330 with the measurement probe 160. Alternatively, the position of the object T may be accurately measured by measuring the characteristic shape of the object T itself. Specifically, for each of a plurality of corners of the object T, the positions of the three faces surrounding the corners may be measured by light, measurement the positions and orientations of the faces that are not orthogonal to each other may be measured by measurement light at three or more points per face, or the positions of a plurality of holes on the object T may be measured by measurement light. When the position of the object T can be accurately measured, the shape of the object T can be automatically brought into close to any shape (planar or the like) of the object T and measured by using computer aided design (CAD) data of the object T acquired in advance.

At the time of the measurement, in order to prevent a probe tip part 164 of the measurement probe 160 from erroneously colliding with the object T due to an error in the CAD data or a position error of the multi-joint robot 500, the direction of the measurement light emitted from the measurement probe 160 is switched to a first direction 300a or a second direction 300b to perform control so that a distance to the object T does not become equal to or smaller than a predetermined threshold value. Thereby, it is possible to measure a three-dimensional shape of the object T.

### Configuration Example of Measurement Probe 160

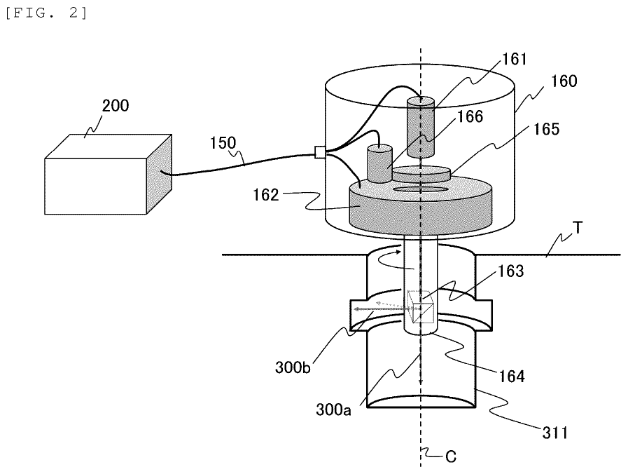

Next, FIG. 2 shows a configuration example of the measurement probe 160. The measurement probe 160 is connected to a probe control device 200 via a connection cable 150.

The probe control device 200 outputs measurement light generated by a built-in distance measuring source to the measurement probe 160 via the connection cable 150.

The connection cable 150 includes an optical fiber that propagates the measurement light, and guides the measurement light to the measurement probe 160. The connection cable 150 also guides reflected light from the object T to the probe control device 200.

The measurement probe 160 irradiates the object T with the measurement light input from the probe control device 200, and outputs the reflected light from the object T to the probe control device 200.

The measurement probe 160 includes a lens system 161, a rotation mechanism 162, an optical path switching element 163, the probe tip part 164, a polarization state control unit 165, and a polarization state control unit drive unit 166.

The lens system 161 narrows the measurement light input from the probe control device 200 via the connection cable 150 and guides it to the polarization state control unit 165. The rotation mechanism 162 is constituted by a motor or the like. The rotation mechanism 162 rotates the probe tip part 164 around a rotating shaft C parallel to the measurement light input from the lens system 161 under the control of the probe control device 200.

The optical path switching element 163 is constituted by, for example, a polarized beam splitter. The optical path switching element 163 has an optical path switching function, and selectively emits the measurement light, whose polarization state has been controlled by the polarization state control unit 165, in a first direction 300a, which is the same traveling direction as the measurement light output from the lens system 161, or in a second direction 300b, which is substantially orthogonal to the first direction 300a, in accordance with the polarization direction of the measurement light. Hereinafter, measurement light emitted in the first direction 300a will be referred to as measurement light 300a, and measurement light emitted in the second direction 300b will be referred to as measurement light 300b.

The probe tip part 164 locks the optical path switching element 163 and transmits light emitted from the optical path switching element 163. The probe tip part 164 has a cylindrical shape with an opening portion in the first direction 300a, and locks the optical path switching element 163 with at least a part of the inner wall. The probe tip part 164 is rotated around the rotating shaft C by the rotation mechanism 162. As the probe tip part 164 rotates, the optical path switching element 163 locked by the probe tip part 164 also rotates.

The configuration of the probe tip part 164 is not limited to the above-described configuration example. For example, the optical path switching element 163 may be locked by one or more supports, and the optical path switching element 163 may rotate as the supports are driven. In addition, the probe tip part 164 may be constituted by, for example, a transparent two-layered tube, and the optical path switching element 163 may be locked by its inner tube and rotated.

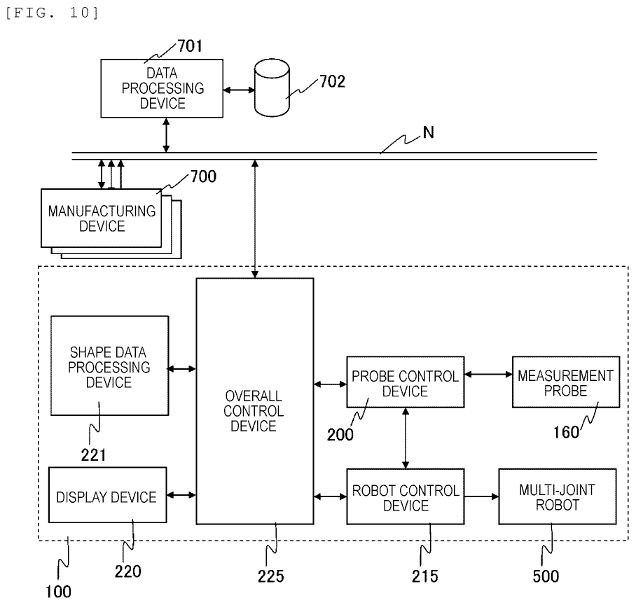

The polarization state control unit 165 is constituted by, for example, a wavelength plate, a liquid crystal element, and the like, and controls the polarization of the measurement light input from the lens system 161 under the control of the probe control device 200 (FIG. 10). Specifically, the polarization state control unit 165 can change the polarization direction of the measurement light input from the lens system 161.

The polarization state control unit drive unit 166 rotates and drives the polarization state control unit 165 to change the polarization direction of the measurement light input from the lens system 161.

In the measurement probe 160, the measurement light input from the probe control device 200 via the connection cable 150 reaches the polarization state control unit 165 via the lens system 161, and the polarization of the measurement light is controlled by the polarization state control unit 165, whereby the measurement light reaches the optical path switching element 163.

The measurement light 300a that has passed through the optical path switching element 163 in accordance with the polarization direction reaches the object T from the opening portion of the probe tip part 164. Reflected light that is reflected or scattered by the object T travels in the opposite direction to the path of the emitted measurement light 300a, that is, through the optical path switching element 163, the polarization state control unit 165, the lens system 161, and the connection cable 150 in this order and reaches the probe control device 200.

The probe control device 200 photoelectrically converts the reflected light that has reached it into an electrical signal and calculates a distance to the object T. In this embodiment, the photoelectric conversion of the reflected light is performed by the probe control device 200, but a photoelectric conversion means (not shown) may be provided in the measurement probe 160 so that an electrical signal corresponding to the reflected light is output from the measurement probe 160 to the probe control device 200.

For example, as shown in FIG. 2, when the shape of a cylindrical hole 311 of the object T is measured, the polarization state control unit 165 controls the polarization to emit the measurement light 300a, and the depth to the bottom of the hole 311 can be measured.

On the other hand, the measurement light 300b emitted laterally from the optical path switching element 163 in accordance with a polarization direction passes through the opening portion of the side surface of the probe tip part 164 or a wall surface thereof and is emitted onto the object T. The reflected light reflected or scattered by the object T travels back along the path of the measurement light 300b to reach the probe control device 200, and a distance to the object T is calculated. When the measurement light 300b is used, for example, the shape of the side surface of the hole 311 can be measured. While the measurement light 300b is being emitted, the optical path switching element 163 can be rotated together with the rotation of the probe tip part 164, and thus, in this case, the shape of the entire circumference of the side surface of the hole 311 can be measured.

In this embodiment, the measurement probe 160 can switch between emission of the measurement light 300a and emission of the measurement light 300b. However, for the main purpose of the invention, which is to measure a three-dimensional shape by scanning with a multi-joint robot, it is not necessary to emit the measurement light 300b, but it is sufficient to emit the measurement light 300a.

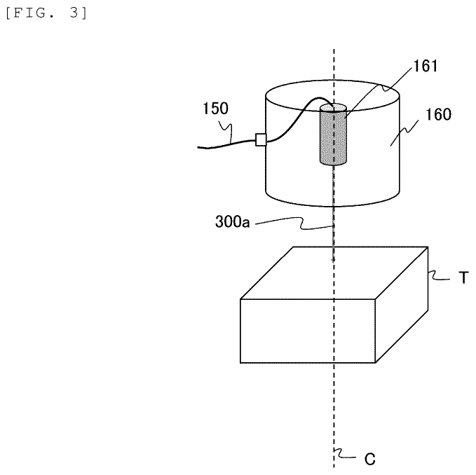

Next, FIG. 3 shows a modification example of the measurement probe 160 that emits only the measurement light 300a.

The modification example is a so-called laser distance measuring sensor. In this modification example, the rotation mechanism 162, the optical path switching element 163, the probe tip part 164, the polarization state control unit 165, and the polarization state control unit drive unit 166 are omitted from the configuration example in FIG. 2.

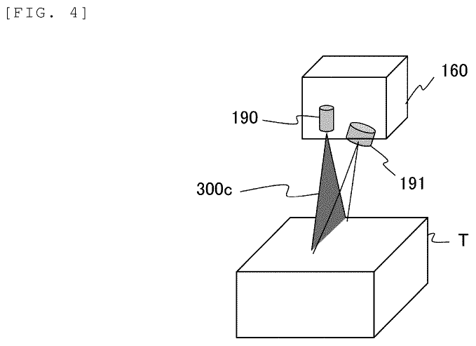

Next, FIG. 4 shows another modification example of the measurement probe 160. This modification example is a so-called laser light cutting sensor, and includes a lens system 190 that emits measurement light as a sheet-like beam 300c that spreads in a fan shape, and a light receiving unit 191 that receives reflected light from the object T. In this modification example, the lens system 190 emits measurement light as the beam 300c to the object T, and the light receiving unit 191 images the pattern of luminous lines on the object T due to the emission, and the shape of an area irradiated with the beam 300c is measured using the principle of triangulation on the basis of an imaging result.

Although not shown in the drawing, as still another modification example, a displacement sensor may be adopted for the measurement probe 160. The displacement sensor emits a linear beam to the object T instead of the sheet-like beam 300c that spreads in a fan shape as shown in FIG. 4, detects the position of one luminous point on the object T due to the emission by the light receiving unit 191, and measures a distance to the one point by the triangulation principle.

### Three-Dimensional Shape Measurement of Object T Using Shape Measurement Device 100₁

Hereinafter, three-dimensional shape measurement of the object T using the shape measurement device 100₁ will be described.

In general, multi-joint robots realize operations of multiple degrees of freedom by combining movements of a plurality of rotation axes. For example, the multi-joint robot 500 (FIG. 1) realizes turning and vertical movement of an arm L1, which is equivalent to an upper arm of a human being, by the drive shafts A1 and A2 which are equivalent to a shoulder joint of a human being. The multi-joint robot 500 also realizes bending and straightening of an arm L2, which is equivalent to a forearm of a human being, by the drive shaft A3 which is equivalent to an elbow joint of a human being. The multi-joint robot 500 also achieves the rotation of the arm L2 by the drive shaft A4. The multi-joint robot 500 also realizes bending and turning of the arm L3, which is equivalent to corresponds to a hand of a human being, by the drive shafts A5 and A6 which are equivalent to a wrist joint of a human being. A flange 502 is provided at the end 501 of the arm L3, and a distance to an object is measured by attaching the measurement probe 160 to the flange 502.

The multi-joint robot 500 can position and hold the measurement probe 160 attached to the flange 502 at any position and in any orientation by combining the movements of the drive shafts A1 to A6. However, the measurement probe 160 attached to the flange 502 can generally have a position error exceeding 1 mm because errors of the angles of the drive shafts, errors of an inter-axial distance, and the like are accumulated and appear.

For this reason, when the measurement probe 160 is attached to the flange 502 and the measurement probe 160 is scanned linearly to measure a step shape on the surface of the object T while measuring a distance to the object T, the trajectory of the measurement probe 160 cannot maintain a straight line and will meander, and thus this error will affect the measurement results. For example, the error in the trajectory during linear movement depends on the accuracy of the multi-joint robot 500, but can be as small as approximately 0.2 mm or as large as more than 1 mm.

Consequently, in this embodiment, one of the drive shafts A1 to A6 is selected as the drive shaft to be driven when measuring a distance to the object T, and the measurement probe 160 is attached to the flange 502 so that the selected drive shaft and the measurement light 300a emitted from the probe tip part 164 are substantially parallel to each other. As long as the measurement probe 160 can be fixed to the multi-joint robot 500 at a desired position and in a desired orientation, other attachment members (fixing members) may be used instead of the flange 502.

A user selects a shaft to be driven by selecting a drive shaft that can be substantially parallel to the perpendicular line of a surface 310 to be measured of the object T or to the axis of the hole 311 to be measured. In other words, the user may select a drive shaft that can be substantially parallel to the perpendicular line of the surface to be scanned with the measurement light 300a. When there are a plurality of drive shafts that can be selected, it is desirable to select the drive shaft closest to the tip (in this case, the drive shaft A6).

For example, when the depth of the hole 311 opening in the surface 310 on the object T is measured, the probe tip part 164 of the measurement probe 160 may be scanned in parallel with the surface 310 on the object T or along a reference surface 390 perpendicular to the axis of the hole 311. In addition, as a preliminary step, the orientation of the multi-joint: robot 500 may be adjusted by appropriately driving the other drive shafts A1 to A5 so that the drive shaft A6 to be driven is substantially orthogonal to the reference surface 390.

When an inter-axial distance between the drive shaft A6 and the measurement light 300a is R, and the drive shaft A6 is rotated at an angular velocity V, scanning is performed with the measurement light while drawing an arc-shaped trajectory at a circumferential velocity VR. The arc-shaped trajectory at this time can suppress vibration because only the tip part of the multi-joint robot 500, which has a small mass, is rotated. In addition, among the six drive shafts A1 to A6 provided in the multi-joint robot 500, only the drive shaft A6 is moved, and thus it is possible to suppress meandering of the trajectory due to the accumulated errors of the respective axes.

Thus, although it depends on the accuracy of the operation of the multi-joint robot 500, the vibration and meandering width of the scanning trajectory of the measurement light 300a can be suppressed to approximately 20 μm to 50 μm when only the drive shaft A6 is driven.

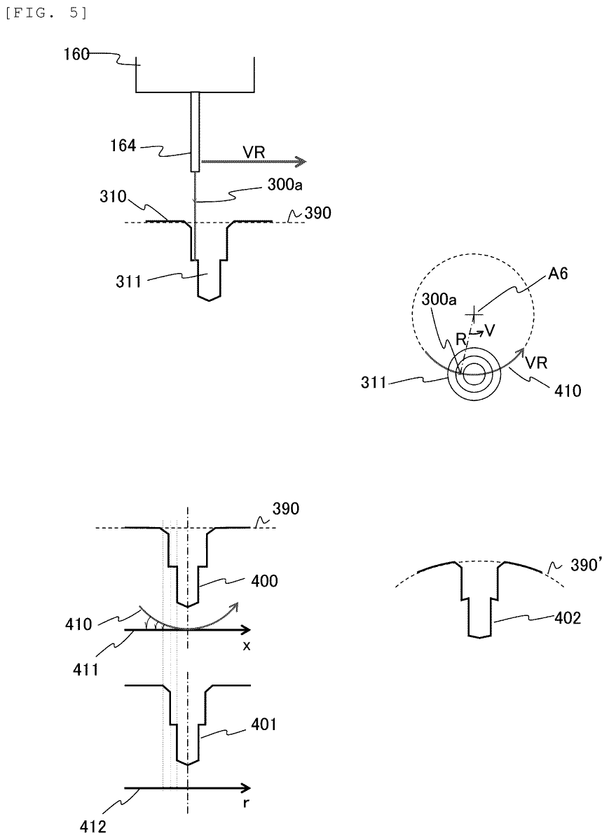

Next, FIG. 5 is a diagram showing a first example of scanning of the measurement probe 160 and a method of processing a measured profile.

As shown in the upper part of the drawing, scanning is performed with the measurement light 300a from the probe tip part 164 along the reference surface 390. In order to realize this scanning by rotating the drive shaft A6, the position and orientation of the drive shaft A6 is held by the remaining drive shafts A1 to A5 of the multi-joint robot 500 so that the axis of the hole 311 to be measured is positioned at a position offset from the drive shaft A6 by the inter-axial distance R, as shown in a top view of the reference surface 390 viewed from the measurement probe 160 side shown in the middle part of the drawing.

In this state, when only the drive shaft A6 is driven at the angular velocity V, scanning is performed with the measurement light 300a emitted from the probe tip part 164 along an arc-shaped scanning trajectory 410 centered on the drive shaft A6 at a circumferential velocity VR.

At this time, since the other drive shafts A1 to A5 are stationary, there is no effect from these drive errors, and a distance of the probe tip part 164 to the reference surface 390, which depends on the accuracy of only the drive shaft A6, does not fluctuate up and down, and thus it is possible to realize a smooth arc-shaped scanning with a constant circumferential velocity VR.

A drawing on the lower left side of the drawing shows a profile 400 of the hole 311 which is measured in this manner. However, the measured profile 400 corresponds to the arc-shaped scanning trajectory 410, and a horizontal axis x 411 is a distance along the scanning trajectory 410. In many cases, a profile corresponding to a linear trajectory passing through the center of the hole 311 is inherently desired to be obtained, and thus conversion is performed in this case. A distance r 410 from the hole 311 at each point along the scanning trajectory 410 is calculated, and the horizontal axis is converted from x to r. In this manner, the profile 400 corresponding to the arc-shaped scanning trajectory 410 can be converted into a profile 401 corresponding to a linear scanning trajectory.

Furthermore, the drive shaft A6 may be inclined relative to the reference surface 390 due to an error in the operation of the multi-joint robot 500 or an error in the installation of the object T, and a distance between the scanned measurement probe 160 and the reference surface 390 may not be constant. As a result, the measured profile may be distorted, for example, like a profile 402 as shown in the lower right side of the drawing. For example, when the inclination of the drive shaft A6 relative to the reference surface 390 is 0, a distance to the reference surface 390 will change to an elliptical shape, like a curved surface 390′, and a ratio of the major axis to the minor axis of the ellipse will be sine.

In order to correct this, a distance to the known flat surface 310 around the hole 311 is measured, and the ellipse is fitted to the shape of a portion of the measured profile 401 which corresponds to the flat surface 310. Then, the profile 402 may be converted into the profile 400 on the basis of the obtained elliptical curved surface 390′, and the profile 400 may be converted into the profile 401.

In the above description, the drive shaft A6 closest to the tip of the multi-joint robot 500 is selected as the drive shaft to driven when the measurement probe 160 is scanned, but other drive shafts may be selected as long as they satisfy the above-described conditions.

For example, when the upper surface of the object T shown in FIG. 1 and the shape of the hole opened in the upper surface are measured, the orientation of the multi-joint robot 500 may be adjusted so that the probe tip part 164 is perpendicular to the upper surface of the object T, and then the drive shaft A1 may be driven to turn instead of the drive shaft A6. In this case, since the turning radius of the drive shaft A1 is larger than that of the drive shaft A6, the scanning trajectory 410 can be made closer to a linear shape. However, since the mass and moment of inertia of the turning part are larger than when the drive shaft A6 is driven, the vibration of the scanning trajectory becomes larger, and thus this is not suitable for measuring anything other than a substantially horizontal plane.

In this embodiment, the multi-joint robot 500 is configured as a 6-axis vertical multi-joint robot, but a robot having 7 or more redundant drive shafts may be adopted for the multi-joint robot 500. In this case, when the drive shafts are assumed to be A1, A2, . . . , A7 in order from the base, it is preferable to adjust the position and orientation of the drive shaft A7 SO that it is substantially perpendicular to the reference surface 390 by using the drive shafts A1 to A6 and to perform scanning with the measurement light 300a by turning only the drive shaft A7.

Alternatively, the position and orientation of the drive shaft A6 may be adjusted to be substantially perpendicular to the reference surface 390 by using the drive shafts A1 to A5, scanning with the measurement light 300a may be performed by turning only the drive shaft A6, and the drive shaft A7 may be used to adjust the direction of the measurement light 300a as viewed from the drive shaft A6.

In this manner, a robot with seven or more redundant drive shafts is adopted, and thus it is possible to bring the probe tip part 164 close to an object T having a more complicated shape and to perform scanning with the measurement light 300a. Furthermore, when the measurement light 300b is emitted by turning the probe tip part 164, more diverse scanning can be performed.

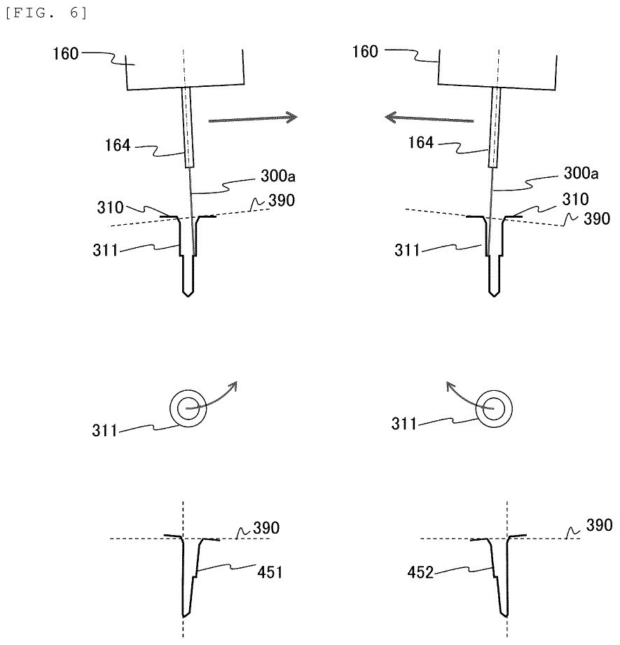

Next, FIG. 6 is a diagram showing a second example of scanning of the measurement probe 160 and a method of processing a measured profile.

When there is a step shape inside the hole 311 of the object T and the width thereof is narrow, the step shape may not be detected even when scanning is performed with the measurement light 300a parallel to the axis of the hole 311. The second method is suitable for such a case.

When a right edge of the hole 311 is measured, scanning with the measurement light 300a is performed as shown on the middle left side of the drawing by inclining the measurement probe 160 slightly to the left with respect to the axis of the hole 311 so that the reference surface 390 on which scanning with the measurement light is performed with respect to the flat surface 310 surrounding the hole 311 is slightly inclined upwards to the right as shown on the upper left side of the drawing. Thereby, as shown on the lower left side of the drawing, it is possible to obtain a profile 451 that reflects a side surface shape on the right side of the hole 311 but does not reflect a side surface shape on the left side.

In contrast, when a left edge of hole 311 is measured, scanning with the measurement light 300a is performed as shown on the middle right side of the drawing by inclining the measurement probe 160 slightly to the right with respect to the axis of the hole 311 so that the reference surface 390 on which scanning with the measurement light is performed with respect to the flat surface 310 surrounding the hole 311 is slightly inclined upwards to the left as shown on the upper right side of the drawing. Thereby, it is possible to obtain a profile 452 that reflects a side surface shape on the left side of the hole 311 but does not reflect a side surface shape on the right side, as shown on the lower right side of the drawing.

When the two profiles 451 and 452 obtained in this manner are combined such that the inclinations of the flat surfaces around the hole 311 match each other, it is possible to measure the shape of a fine step inside the hole 311, a slightly overhanging shape (not shown), or the like.

### Modification Example of Probe Tip Part 164

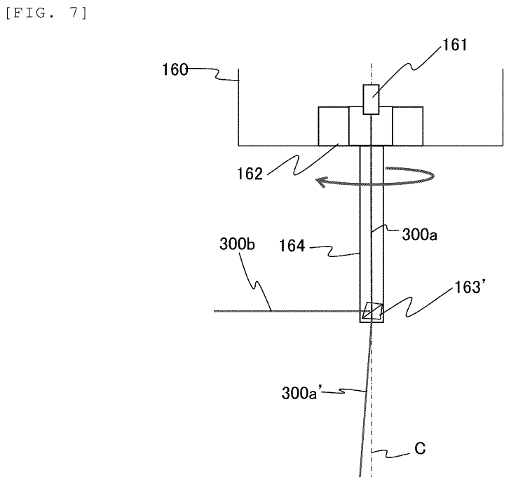

Next, FIG. 7 shows a modification example of the probe tip part 164. The probe tip part 164 in this modification example differs from the probe tip part 164 in FIG. 2 in that an optical path switching element 163′ that is locked at the tip thereof is inclined compared to the optical path switching element 163 in FIG. 2. Components other than the optical path switching element 163′ are the same as the components of the measurement probe 160 shown in FIG. 2 and are given the same reference numerals, and thus the description thereof will be omitted.

Similarly to the optical path switching element 163, the optical path switching element 163′ is constituted by, for example, a polarized beam splitter. The optical path switching element 163′ has an optical path switching function, and emits measurement light whose polarization state has been controlled by the polarization state control unit 165 in at least one of the following directions: a third direction 300a′ slightly inclined from the first direction 300a, which is the same traveling direction as the traveling direction of the measurement light output from the lens system 161, and a second direction 300b, which is substantially orthogonal to the first direction 300a. Hereinafter, the measurement light in the third direction 300a′ will be referred to as measurement light 300a′. The inclination in the third direction 300a′ with respect to the first direction 300a is, for example, 0.5 degrees or more and 10 degrees or less.

In this modification example, the direction of the measurement light 300a′ can be adjusted by rotating the probe tip part 164 while fixing the position of the measurement probe 160.

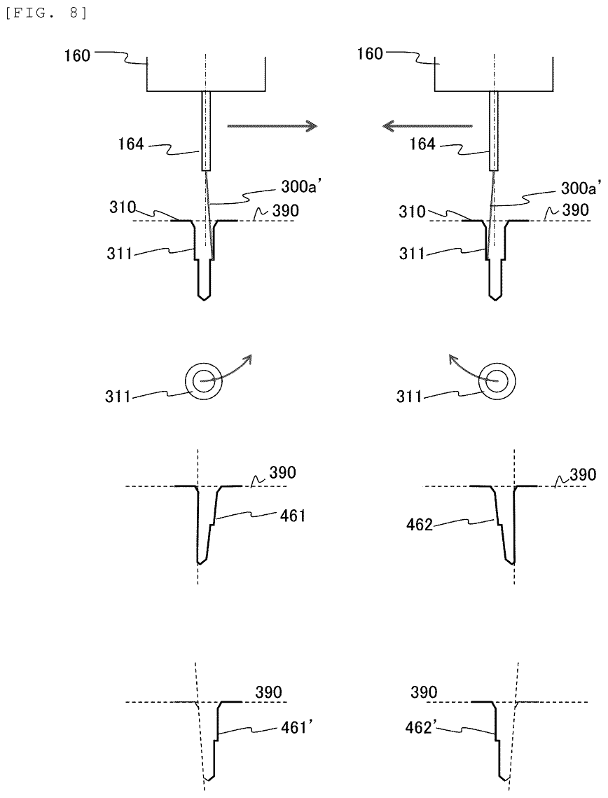

FIG. 8 is a diagram showing an example of scanning of the measurement probe 160 and a method of processing a measured profile when this modification example is attached to the tip of the multi-joint robot 500.

In this case, similarly to FIG. 1, the measurement probe 160 is held such that the reference surface 390 of scanning and the drive shaft A6 of the robot are substantially perpendicular to each other, and the rotating shaft of the probe tip part 164 and the axis of the hole 311 are substantially parallel to each other. In the measurement of the right edge of the hole 311, as shown on the left side of a first row in the drawing, the rotation angle of the probe tip part 164 is controlled such that the tip of the measurement light 300a′ is inclined to the right side of the drawing. Then, as shown in the left side of a second row in the drawing, the drive shaft A6 is turned to perform scanning with the measurement light 300a′. Thereby, as shown on the left side of a third row in the drawing, it is possible to obtain a profile 461 that reflects a side surface shape on the right side of the hole 311 but does not reflect a side surface shape on the left side.

In contrast, when a left edge of hole 311 is measured, as shown on the right side of the first row in the drawing, the rotation angle of the probe tip part 164 is controlled such that the tip of the measurement light 300a′ is inclined to the left side of the drawing. Then, as shown on the right side of the second row in the drawing, the drive shaft A6 is turned to perform scanning. Thereby, as shown on the right side of the third row in the drawing, it is possible to obtain a profile 462 that reflects the side surface shape on the left side of hole 311 but does not reflect the side surface shape on the right side.

However, the obtained two profiles 461 and 462 are distorted obliquely by an amount that the measurement light 300a′ is inclined from the perpendicular line of the reference surface 390. Consequently, as shown in a fourth row in the drawing, the distortion is removed from the profiles 461 and 462, and the resulting profiles 461′ and 462′ are combined. Thereby, it is possible to measure the shape of a fine step inside the hole 311, a slightly overhanging shape (not shown), or the like.

### Configuration Example of Shape Measurement Device 100₂ According to Second Embodiment of Invention

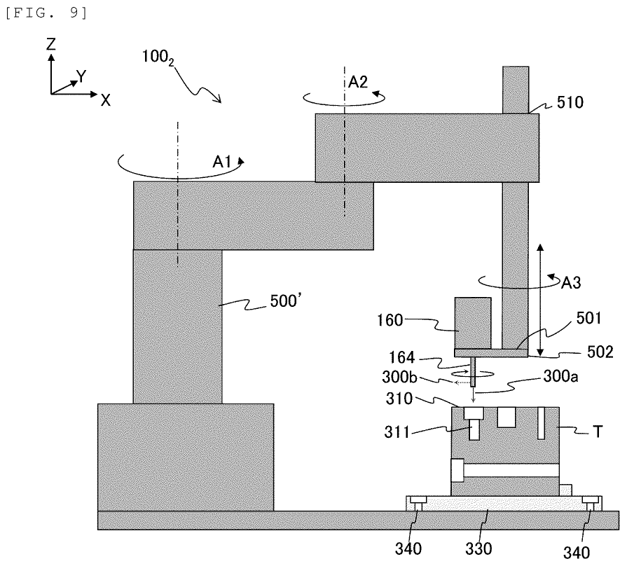

Next, FIG. 9 shows a configuration example of a shape measurement device 100₂ according to a second embodiment of the invention.

The shape measurement device 100₂ is a device in which the multi-joint robot 500, which is a 6-axis vertical multi-joint robot in the shape measurement device 100₁ (FIG. 1) according to the first embodiment, is replaced with a multi-joint robot 500′ for which a SCARA type robot is adopted. Components of the shape measurement device 100₂ other than the multi-joint robot 500′ are the same as those of the shape measurement device 100₁ (FIG. 1) and are given the same reference numerals, and thus the description thereof will be omitted.

The multi-joint robot 500′ includes drive shafts A1, A2, and A3 with rotation axes in a vertical direction. The multi-joint robot 500′ also includes a lifting unit 510 that raises and lowers an end 501 in the same axial direction (Z direction) as the drive shaft A3 at the tip. The multi-joint robot 500′ determines the position of the end 501 on the XY plane by turning of the drive shafts A1 and A2. The multi-joint robot 500′ also determines the Z coordinate of the end 501 by raising and lowering of the lifting unit 510. Instead of or in addition to the lifting unit 510, a lifting unit that rises and falls in the same axial direction as the drive shaft A1 or the drive shaft A2 may be provided.

The measurement probe 160 is attached to the flange 502 provided at the end 501 of the multi-joint robot 500′. At this time, the drive shaft A3 and the measurement light 300a emitted from the probe tip part 164 are attached such that they are substantially parallel to each other. In this case, the emission direction of the measurement light 300a is vertical. Thus, this embodiment is suitable for measuring the horizontal surface of the object T and the shape of a hole or the like opened in the horizontal surface.

When the inter-axial distance between the drive shaft A3 and the measurement light 300a is R, and the drive shaft A3 is rotated at an angular velocity V, the measurement light moves at a circumferential velocity VR while drawing a trajectory in an arc shape. The trajectory at this time can suppress vibration because only the tip part of the multi-joint robot 500′, which has a small mass, is rotated. In addition, among the drive shafts A1 to A3 and the lifting unit 510 which are included in the multi-joint robot 500′, only the drive shaft A3 is moved, and thus it is possible to suppress meandering of the trajectory due to accumulated errors of the respective drive parts.

In addition, the above-described scanning may be realized by turning only the drive shaft A1 or turning only the drive shaft A2 in the drive mechanism of the multi-joint robot 500′. In this case, the drive shaft A3 at the tip of the multi-joint robot 500′ may be a fixed shaft that does not either rotate or drive.

Further, in the shape measurement device 100₂, the measuring light 300b can be emitted from the probe tip part 164, and a depth profile of the hole 311 can be measured by moving only the lifting unit 510 of the drive mechanism of the multi-joint robot 500′. In this case, high-precision scanning with measuring light can be performed with only one drive part. The direction of the measuring light 300b can be adjusted arbitrarily by the turning angle of the probe tip part 164 or the turning of the drive shaft A3 of the multi-joint robot 500′. In this case, it is also possible to measure the shape of the outer surface of the object T by vertically irradiating the outer surface of the object T with the measuring light 300b.

Hereinafter, when it is not necessary to individually distinguish between the shape measurement devices 100₁ and 100₂, they will be referred to as the shape measurement device 100. The same applies to the multi-joint robots 500 and 500′.

### Configuration Example of Measurement System Including Shape Measurement Device 100

Next, FIG. 10 shows a configuration example of a measurement system including the shape measurement device 100.

The measurement system includes the shape measurement device 100, a manufacturing device 700, and a data processing device 701, which are connected via a network N such as a local area network (LAN) or a wide area network (WAN).

The shape measurement device 100 includes a robot control device 215, a display device 220, a shape data processing device 221, and an overall control device 225, in addition to the above-described measurement probe 160, probe control device 200, and multi-joint robot 500.

In the shape measurement device 100, the overall control device 225 causes the robot control device 215 to control the multi-joint robot 500 and causes the probe control device 200 to control the measurement probe 160, thereby performing 3D shape measurement of the object T.

In addition, the overall control device 225 outputs position orientation information of the multi-joint robot 500 obtained from the robot control device 215 and 3D shape data of the measurement probe 160 obtained from the probe control device 200 to the shape data processing device 221.

The shape data processing device 221 is equivalent to a conversion unit and a correction unit of the invention. The shape data processing device 221 synthesizes the overall 3D shape data of the object T on the basis of the position orientation information of the multi-joint robot 500 and the 3D shape data from the measurement probe 160. That is, since the 3D shape data of the object T obtained from the measurement probe 160 is relative data to the position and orientation of the measurement probe 160 at the time of measurement, the shape data processing device 221 calculates the position and orientation of the measurement probe 160 at the time of measurement from the position orientation information of the multi-joint robot 500 and synthesizes the overall 3D shape data of the object T by converting the 3D shape data into a reference coordinate system.

The shape data processing device 221 also analyzes the obtained overall 3D shape data of the object T or 3D shape data of each narrow portion of the object T to calculate an error between the designed shape of the object T and the actual shape on the basis of design information of the object T, for example, calculate dimensional information such as the depth, diameter, and pitch of the hole, and calculate geometric tolerance information such as cylindricity, straightness, and flatness.

Furthermore, the overall control device 225 causes the display device 220 to display calculation results obtained by the shape data processing device 221.

Furthermore, the overall control device 225 outputs the calculation results obtained by the shape data processing device 221 to the data processing device 701 via the network N. The data processing device 701 stores the calculation results obtained by the shape data processing device 221 in the storage device 702. The data processing device 701 then analyzes the error of the object T on the basis of the calculation results obtained by the shape data processing device 221 stored in the storage device 702, and controls the manufacturing device 700 that processes the object T. Specifically, the data processing device 701 instructs the manufacturing device 700 to replace tools and to change machining conditions such as a tool size correction amount, a machining path, and a machining speed. The data processing device 701 also instructs the manufacturing device 700 to change the amount of finishing machining and designate a combination of objects T to be assembled in an assembly process of assembling the objects T in consideration of shape errors of the objects T to be assembled.

The invention is not limited to the above-described embodiment, and various modifications can be made. For example, the above-described embodiment has been described in detail to describe the invention in an easy-to-understand manner, and is not necessarily limited to having all of the configurations described. In addition, a part of the configuration of one embodiment can be replaced with or added to the configuration of another embodiment.

With regard to the above-described configurations, functions, processing units, and the like, some or all of these may be realized by hardware, for example, by being designed as an integrated circuit. Further, the above-described configurations, functions, and the like may be realized by software by a processor analyzing and executing a program for realizing each of the functions. Information such as programs, tables, and files for realizing the functions can be placed in a recording device such as a memory, a hard disk, or an SSD or a recording medium such as an IC card, an SD card, or a DVD. In addition, the control lines and information lines are those that are considered to be necessary for the description, and not all control lines and information lines in the product are necessarily shown. In reality, it may be considered that almost all components are connected to each other.

### REFERENCE SIGNS LIST

100₁, 100₂: shape measurement device
150: connection cable
160: measurement probe
161: lens system
162: rotation mechanism
163, 163′: optical path switching element
164: probe tip part
165: polarization state control unit
166: polarization state control unit drive unit
190: lens system
191: light receiving unit
200: probe control device
215: robot control device
220: display device
221: shape data processing device
225: overall control device
330: sample stage
500, 500′: multi-joint robot
501: end
502: flange
510: lifting unit
700: manufacturing device
701: data processing device
702: storage device

1.-12. (canceled)

13. A shape measurement device comprising:
a multi-joint robot having a plurality of drive shafts; and
a non-contact distance measuring sensor attached to the multi-joint robot, wherein
the multi-joint robot drives only a predetermined single shaft among the plurality of drive shafts to scan an object with measurement light emitted from the non-contact distance measuring sensor, and
the predetermined single shaft is substantially parallel to the measurement light and substantially perpendicular to an actual surface of the object or a reference surface assumed for the object.

14. The shape measurement device according to claim 13, wherein the multi-joint robot turns only the predetermined single shaft to perform scanning in an arc shape with the measurement light emitted from the non-contact distance measuring sensor.

15. The shape measurement device according to claim 13, wherein the predetermined single shaft is determined based on angles between the plurality of drive shafts and an actual surface of the object or a reference surface assumed for the object.

16. The shape measurement device according to claim 13, wherein the multi-joint robot is able to change both relative positions and orientations of the non-contact distance measuring sensor and the object by driving the plurality of drive shafts.

17. The shape measurement device according to claim 13, comprising a sample stage on which the object is placed,
wherein the sample stage has a fixed relative positional relationship with the multi-joint robot.

18. The shape measurement device according to claim 13, wherein the non-contact distance measuring sensor is a laser distance measuring sensor that measures a distance to a point, or a laser beam cutting sensor that measures a distance to a point.

19. The shape measurement device according to claim 14, further comprising a conversion unit that converts a profile corresponding to the arc-shaped scanning of the non-contact distance measuring sensor into a profile corresponding to linear scanning of the non-contact distance measuring sensor.

20. The shape measurement device according to claim 15, comprising a correction unit that corrects distortion of a profile caused by an inclination of the predetermined single shaft with respect to the actual surface or the reference surface.

21. The shape measurement device according to claim 13, wherein the non- contact distance measuring sensor emits the measurement light in a direction inclined in a range from 0.5 degrees or more to 10 degrees or less from the turning axis of the predetermined single shaft.

22. A shape measurement method using a shape measurement device including a multi-joint robot having a plurality of drive shafts, and a non-contact distance measuring sensor attached to the multi-joint robot, the method comprising:
causing the multi-joint robot to drive only a predetermined single shaft among the plurality of drive shafts to scan an object with measurement light emitted from the non-contact distance measuring sensor,
wherein the predetermined single shaft is substantially parallel to the measurement light and substantially perpendicular to an actual surface of the object or a reference surface assumed for the object.

23. The shape measurement device according to claim 13, wherein, in a case where there are a plurality of the drive shafts that are substantially parallel to the measurement light and substantially perpendicular to the actual surface of the object or the reference surface assumed for the object, the predetermined single shaft is a drive shaft closest to a tip.
